(19) United States
(12) Patent Application Publication
(10) Pub. No.: US 2016/0301145 A1
(43) Pub. Date: Oct. 13, 2016

(54) ANTENNA APPARATUS

(71) Applicant: SAMSUNG ELECTRO-MECHANICS CO., LTD., Suwon-si (KR)

(72) Inventors: Ho Jin LEE, Suwon-si (KR); Hee Jun PARK, Suwon-si (KR); Jong Yun KIM, Suwon-si (KR)

(73) Assignee: SAMSUNG ELECTRO-MECHANICS CO., LTD., Suwon-si (KR)

(21) Appl. No.: 15/075,958

(22) Filed: Mar. 21, 2016

(30) Foreign Application Priority Data
Apr. 8, 2015 (KR) 10-2015-0049616
Sep. 1, 2015 (KR) 10-2015-0123693

(51) Int. Cl. H01Q 21/28; H01Q 1/52; H01Q 1/38

(52) U.S. Cl. CPC H01Q 21/28; H01Q 1/38; H01Q 1/521

(57) ABSTRACT

An antenna apparatus includes, a substrate, a first antenna pattern extending from the substrate in a lateral direction and configured to transmit and receive first communications signals, and a second antenna pattern spaced apart from the first antenna pattern, extending from the substrate in another lateral direction, and configured to transmit and receive second communications signals.

### CROSS-REFERENCE TO RELATED APPLICATION

This application claims the benefit under 35 USC 119(a) of Korean Patent Application No. 10-2015-0049616 filed on Apr. 8, 2015 and 10-2015-0123693 filed on Sep. 1, 2015, with the Korean Intellectual Property Office, the entire disclosures of which are incorporated herein by reference for all purposes.

### BACKGROUND

1. Field

The following description relates to an antenna apparatus.

2. Description of Related Art

Wireless local area network (WLAN) technology has seen rapid growth in terms of speed and bandwidth availability. For example, the frequency band available for wireless fidelity (Wi-Fi) communications has expanded from the 2.4 GHz band to the 5 GHz band, and has also expanded in terms of bandwidth.

In addition, multiple-input multiple-output (MIMO) technology has appeared, such that the amounts of physical Tx and Rx channels have increased. As a result, support for a larger number of physical apparatuses has been demanded without a decrease in performance of the WLAN.

In addition, while devices supporting Wi-Fi communications have traditionally been limited to personal computers (PCs) and other communication devices. Such devices have gradually been expanded to be all devices and apparatuses used in fields in which data is desired to be transmitted and received, such as home appliances including televisions (TVs), vehicles, and a range of other devices.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

In one general aspect, an antenna apparatus includes, a substrate, a first antenna pattern extending from the substrate in a lateral direction and configured to transmit and receive first communications signals, and a second antenna pattern spaced apart from the first antenna pattern, extending from the substrate in another lateral direction, and configured to transmit and receive second communications signals.

The substrate may have a hexahedral shape, and the first and second antenna patterns may be disposed adjacent to corners of the substrate.

The antenna apparatus may further include a third antenna pattern spaced apart from the first and second antenna patterns, extending from the substrate in the lateral direction, and configured to transmit and receive the first communications signals.

The substrate may have a hexahedral shape, the first and third antenna patterns may be disposed adjacent to opposite corners of a side of the substrate, respectively, and the second antenna pattern may be disposed in a center of a side opposite to the side of the substrate.

The antenna apparatus may further include a fourth antenna pattern spaced apart from the first to third antenna patterns, extending from the substrate in the other lateral direction, and may be configured to transmit and receive the second communications signal.

The substrate may have a hexahedral shape, and the first, second, third, and fourth antenna patterns may be disposed adjacent to each corner of the substrate, respectively.

The antenna apparatus may further include a communications module mounted on the substrate in a vertical direction and may be configured to process the first and second communications signals, wherein the substrate may have a first surface configured to receive the communications module and may provide electrical ground regions for the first and second antenna patterns.

The antenna apparatus may further include a first isolator extending from the substrate in the lateral direction and adjacent to the first antenna pattern or the second antenna pattern.

The antenna apparatus may further include a second isolator extending from the substrate in the lateral direction and may be disposed between the first and second antenna patterns configured to electrically isolate the first and second antenna patterns from each other. The second isolator may further extend from the substrate in a vertical direction.

In another general aspect, an antenna apparatus includes, a substrate, a first antenna part comprising at least one antenna pattern disposed on an edge of the substrate and configured to transmit and receive first communications signals, a second antenna part comprising at least one antenna pattern disposed on the edge of the substrate and configured to transmit and receive second communications signals, and an isolator disposed between the first and second antenna parts and configured to lengthen a surface current path between the first and second antenna parts. The isolator may overlap a portion of the antenna pattern.

The substrate may have a hexahedral shape, the first antenna part may include first and third antenna patterns disposed adjacent to opposite corners on one side of the substrate, respectively, the second antenna part may include a second antenna pattern disposed in a center of the other side of the substrate, and the isolator may be disposed adjacent to a corner of the other side of the substrate.

The antenna apparatus may further include a communications module mounted on the substrate and may be configured to process the first and second communications signals, wherein the substrate may be configured to provide ground regions for the first and second antenna parts.

The antenna apparatus may further include a second isolator extending from the substrate in another lateral direction and may be disposed between the first and second antenna parts and may be configured to lengthen a distance of the surface current path between the first and second antenna parts. A slit may be disposed between the first and second antenna parts and extending through a portion of the substrate. The slit may be straight, have an L shape or a T shape.

Other features and aspects will be apparent from the following detailed description, the drawings, and the claims.

### BRIEF DESCRIPTION OF DRAWINGS

FIG. 1 is a view illustrating an antenna apparatus according to an embodiment;

FIG. 2 is a view illustrating the antenna apparatus of FIG. 1 to which isolators have been added according to an embodiment;

FIG. 3 is a view illustrating an antenna apparatus including four antenna patterns according to an embodiment;

FIG. 4 is a view illustrating an antenna apparatus including three antenna patterns according to an embodiment;

FIG. 5 is a view illustrating a layout of an antenna in the antenna apparatus according to an embodiment;

FIG. 6 is a view illustrating an antenna apparatus having a dipole antenna according to an embodiment;

FIG. 7 is a view illustrating an antenna apparatus having a monopole antenna according to an embodiment;

FIGS. 8A and 8B are views illustrating an antenna apparatus having a loop antenna according to an embodiment;

FIG. 9 is a view illustrating an antenna apparatus having an inverted L type three dimensional antenna according to an embodiment;

FIG. 10 is a view illustrating an antenna apparatus having an inverted F type three dimensional antenna according to another embodiment in the present disclosure;

FIG. 11 is a view illustrating an antenna apparatus having an inverted F-type antenna according to an embodiment;

FIGS. 12A through 12C are three-dimensional views illustrating an antenna apparatus having isolator according to an embodiment;

FIGS. 13A through 13C are views illustrating an antenna apparatus having a slit shape of an isolator according to an embodiment;

FIGS. 14A through 14C are views illustrating first isolators of the antenna apparatus according to an embodiment; and

FIGS. 15A through 15C are views illustrating three-dimensional shape of the first isolators of the antenna apparatus according to an embodiment.

Other features and aspects will be apparent from the following detailed description, the drawings, and the claims.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Unless indicated otherwise, a statement that a first layer is “on” a second layer or a substrate is to be interpreted as covering both a case where the first layer directly contacts the second layer or the substrate, and a case where one or more other layers are disposed between the first layer and the second layer or the substrate.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

The terminology used herein is for describing particular embodiments only and is not intended to be limiting of the following description. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

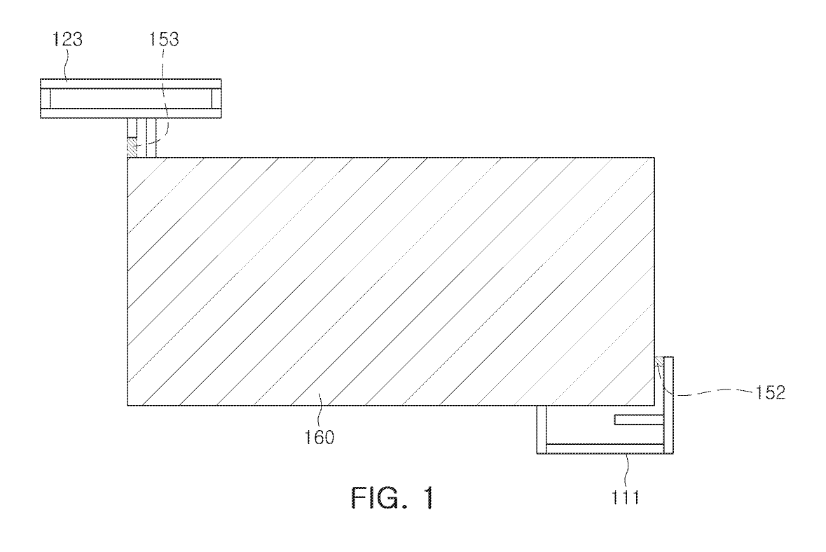

FIG. 1 is a view illustrating an antenna apparatus according to an embodiment. Referring to FIG. 1, the antenna apparatus includes a first antenna pattern 111, a second antenna pattern 123, and a substrate 160. The first antenna pattern 111 extends from the substrate 160 in a lateral direction, and can transmit and receive first communications signals. The first communications signals may be, for example, wireless fidelity (Wi-Fi) signals, but may also be Bluetooth™ signals, or Zigbee™ signals, as well as Wi-Fi signals.

The second antenna pattern 123 is spaced apart from the first antenna pattern 111, extends from the substrate 160 in the lateral direction, and can transmit and receive second communications signals, signals used in a communications scheme different from that of the first communications signals. The second communications signals may be, for example, Bluetooth™′ but may also be Wi-Fi signals, or Zigbee™ signals.

The first antenna pattern 111 and the second antenna pattern 123 are configured in the antenna apparatus, such that the antenna apparatus can transmit and receive multiple signals simultaneously.

In addition, the first and second antenna patterns 111 and 123 are spaced apart from each other. As a spacing distance between the antenna patterns becomes longer, isolation of the antenna patterns may be improved. For example, in a case in which the substrate 160 has a hexahedral shape, the first and second antenna patterns 111 and 123 are disposed at corners of the substrate 160 from the substrate 160 in the lateral direction so as to face each other.

For example, in a case in which the first and second antenna patterns 111 and 123 protrude from the substrate 160 in the lateral direction, a spacing distance between the antenna patterns as compared to a size of the substrate 160 may be increased. Therefore, isolation of the antenna patterns as compared to the size of the substrate 160 may be improved.

Here, the substrate 160 serves as a barrier between the first and second antenna patterns 111 and 123. Therefore, isolation of the antenna patterns may be further improved.

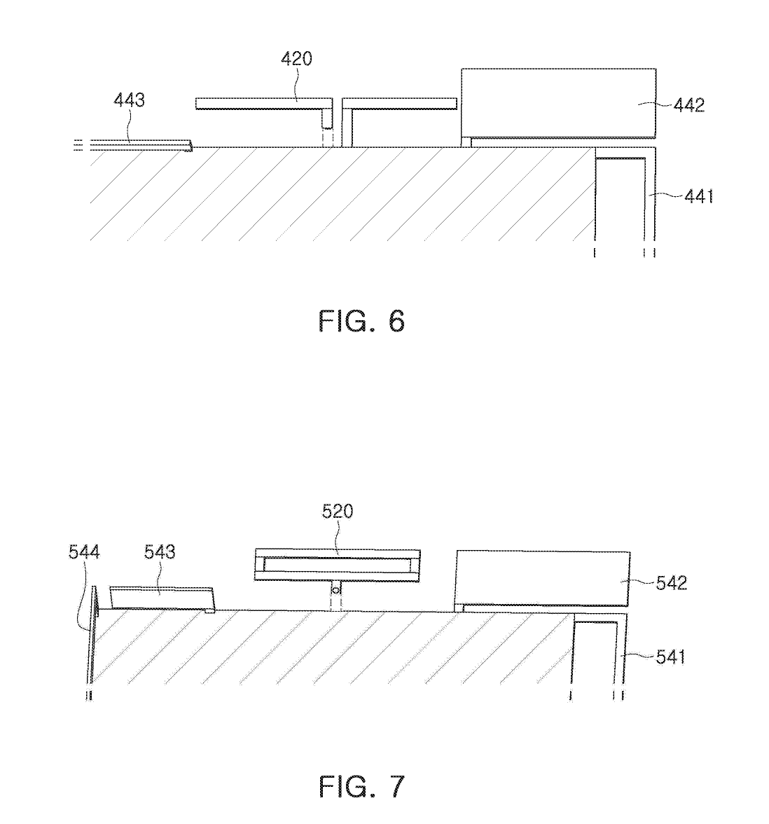

The first and second antenna patterns' 111 and 123 shapes will be described hereinafter with reference to FIGS. 6 through 11.

The antenna apparatus according to an embodiment further includes feed parts 152 and 153 for feeding power to the first antenna pattern 111 and the second antenna pattern 123. In a case in which the substrate 160 provides ground regions for the first and second antenna patterns 111 and 123, surface currents may flow into the first antenna pattern 111 and the second antenna pattern 123 from the feed parts 152 and 153, such that the first and second communications signals are radiated.

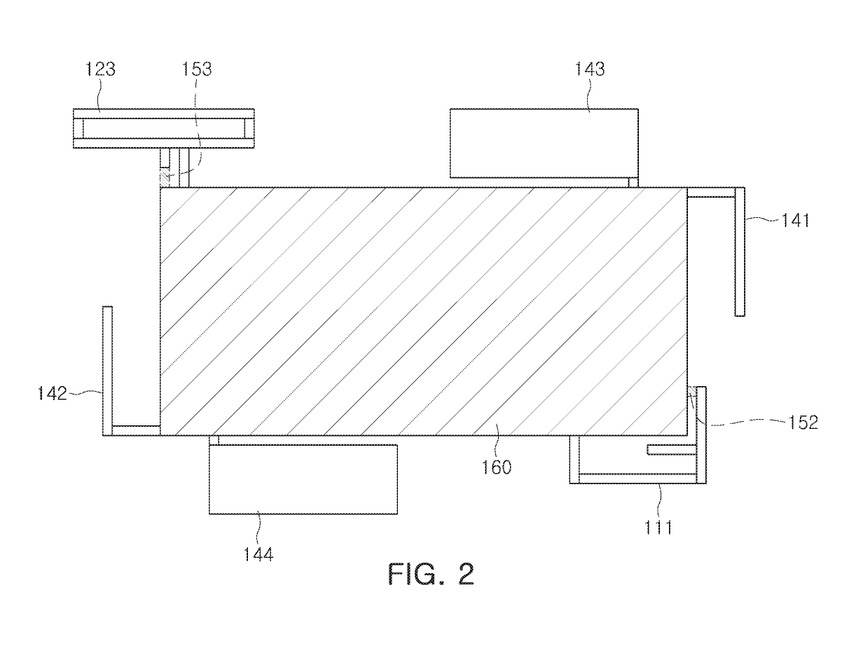

FIG. 2 is a view illustrating the antenna apparatus of FIG. 1 to which isolators have been added. Referring to FIG. 2, the antenna apparatus according to an embodiment includes the first antenna pattern 111, the second antenna pattern 123, isolators 141 through 144, the feed parts 152 and 153, and the substrate 160.

The isolators 141 through 144 are disposed on electrical paths between the first antenna pattern 111 and the second antenna pattern 123 to electrically isolate the first antenna pattern 111 from the second antenna pattern 123.

Here, when the antenna patterns are electrically isolated from each other, the antennas patterns 111 and 123 operate as if a distance between the antenna patterns is significantly increased as compared to the actual distance. For example, in a case in which the first antenna pattern 111 and the second antenna pattern 123 are spaced apart from each other by a first distance, the isolators 141 through 144 cause the first and second antenna patterns 111 and 123 to function as if they are spaced apart from each other by a distance substantially greater than the first distance. In other words, the isolators 141 through 144 prevent the antenna patterns 111 and 123 from interfering with each other by increasing the path a leaked surface current flow must travel.

A distance the isolators 141 through 144 extend may be determined according to a surface current leaked from, or signal interference transmitted by, one of the first and second antenna patterns 111 and 123 to the other thereof. Therefore, the isolation of the antenna patterns may be improved.

For example, the isolators 141 to 144 may be disposed adjacently to corners of side surfaces of the substrate 160. Therefore, the isolation of the antenna patterns may be further improved by preventing signal interference.

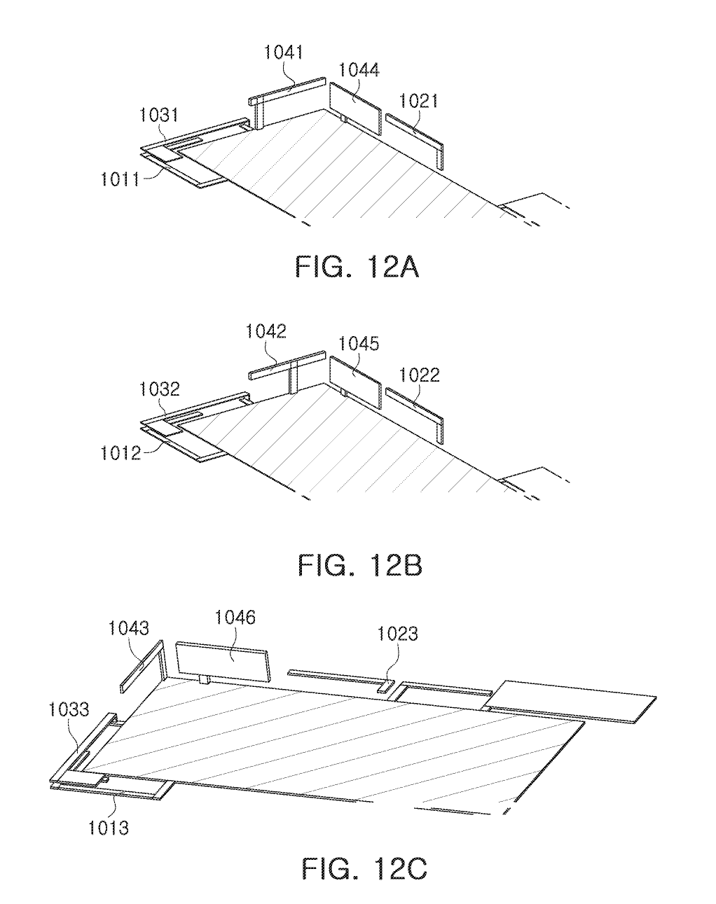

For example, the isolator 141 has an L-shape extending out from the substrate 160 for a distance, then extending, perpendicularly, toward the first antenna pattern 111. The isolator 142 also has an L-shape extending out from the substrate 160 for a distance, then extending, perpendicularly, toward the second antenna pattern 123. Moreover, the isolator 143 has a flag shape of which one surface is directed toward the second antenna pattern 123. The isolator 144 also has a flag shape of which one surface is directed toward the first antenna pattern 111. The flag shape of the isolators 143 and 144 is considered to be a generally rectangular main portion and a post extending from the main portion and contacting the substrate 160, thereby creating a gap between the main portion and the substrate. Shapes of the isolators 141 to 144 will be described later with reference to FIGS. 12A through 15C.

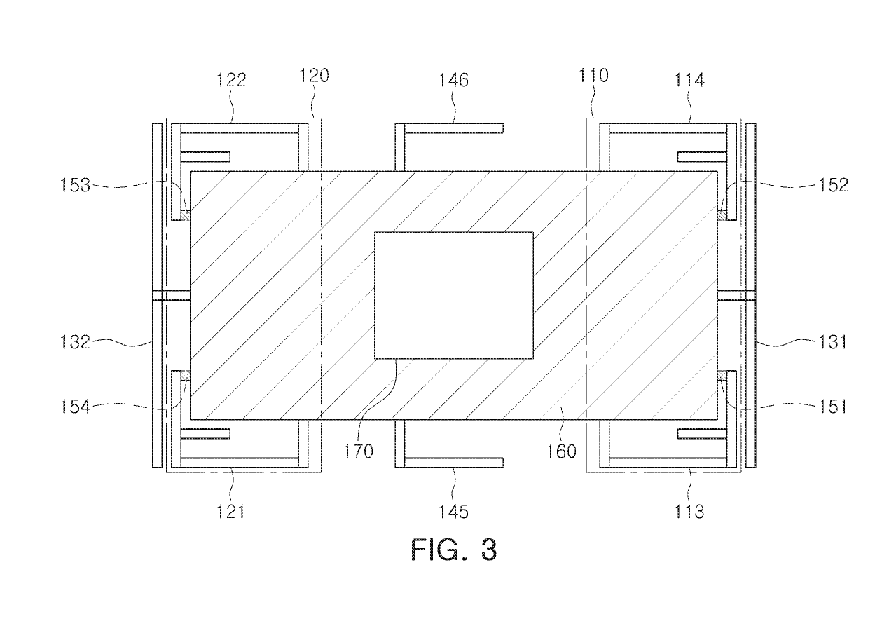

FIG. 3 is a view illustrating an antenna apparatus having four antenna patterns according to another embodiment. Referring to FIG. 3, the antenna apparatus includes a first antenna part 110, a second antenna part 120, first isolators 131 and 132, second isolators 145 and 146, feed parts 151 through 154, a substrate 160, and a communications module 170.

The first antenna part 110 includes first and third antenna patterns 113 and 114 disposed on side surfaces of the substrate 160 and spaced apart from each other, configured to transmit and receive first communications signals.

The second antenna part 120 includes second and fourth antenna patterns 121 and 122 disposed on the side surfaces of the substrate 160 and spaced apart from each other, configured to transmit and receive second communications signals.

For example, in a case in which the substrate 160 has a hexahedral shape, the first, second, third, and fourth antenna patterns 113, 121, 114, and 122 are disposed on the side surfaces at the corners of the substrate 160, respectively. Therefore, isolation of the antenna patterns may be improved.

The first isolators 131 and 132 laterally protrude from the substrate 160, and are disposed to be adjacent to the first, and third, or second and fourth antenna patterns 113, 114, 121, and 122 to assist in formation of a radiation pattern. For example, the first isolators 131 and 132 are coupled to the first antenna part 110, and the second antenna part 120, respectively, in order to adjust the radiation pattern on the basis of a distance, an angle, and a shape, of the antenna patterns. Further, the first isolator 131 is disposed adjacent to the first and third antenna patterns 113 and 114 and have a T shape. The first isolator 132 is disposed adjacent to the second and fourth antenna patterns 121 and 122 and also has a T shape.

The second isolators 145 and 146 allow the first antenna part 110 and the second antenna part 120 to be electrically isolated from each other. The second isolators 145 and 146 may not be coupled to the antenna patterns, unlike the first isolators 131 and 132. Therefore, shapes of the second isolators 145 and 146 may be varied. For example, the second isolator 145 is disposed between the first antenna pattern 113 and the second antenna pattern 121, and the second isolator 146 is disposed between the third antenna pattern 114 and the fourth antenna pattern 122.

The communications module 170 is mounted on a central portion the substrate 160, and is configured to process the first and second communications signals. That is, the substrate 160 provides ground regions for the first and second antenna parts 110 and 120 while providing a mounting area to the communications module 170. In addition, since the communications module 170 is structurally disposed between the first antenna part 110 and the second antenna part 120, isolation of the antenna patterns may be improved. That is, the communications module 170 may be mounted on the substrate 160, whereby a space may be further utilized in the antenna apparatus according to an embodiment.

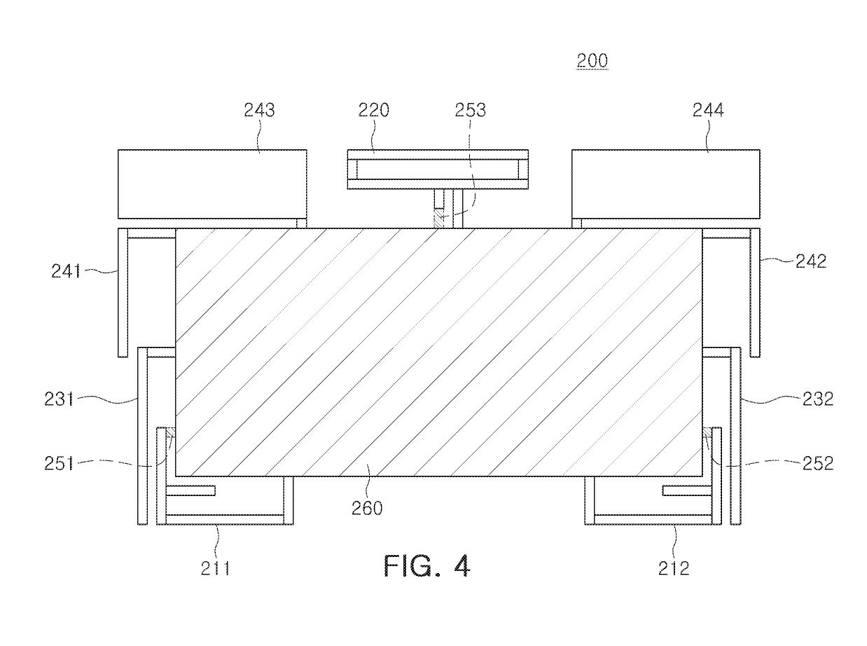

FIG. 4 is a view illustrating an antenna apparatus including three antenna patterns according to an embodiment. Referring to FIG. 4, the antenna apparatus 200 includes first antenna parts 211 and 212, a second antenna part 220, first isolators 231 and 232, second isolators 241 to 244, feed parts 251 to 253, and a substrate 260.

Although a case in which the first antenna parts 211 and 212 include two antenna patterns for a multiple-input multiple-output (MIMO) has been illustrated in FIG. 4, the first antenna parts 211 and 212 are not limited thereto. In each embodiment, the first antenna parts have been illustrated as including two antenna patterns for the purpose of convenience of explanation rather than particularly limiting the disclosure.

The first antenna parts 211 and 212 transmit and receive signals used for a single communications scheme. For example, the two antenna patterns of the first antenna parts 211 and 212 may be symmetrical to each other. The antenna patterns having a symmetrical structure may cut off even order harmonic distortion signals. Therefore, isolation of the two antenna patterns of the first antenna parts 211 and 212 may be improved.

The second antenna part 220 transmits and receives signals used for a communications scheme different from that of the first antenna parts 211 and 212. The first antenna parts 211 and 212 and the second antenna part 220 are included together in the antenna apparatus 200, whereby the antenna apparatus 200 may perform multiple communications.

In addition, the first antenna parts 211 and 212 and the second antenna part 220 are spaced apart from each other. As a spacing distance between the antenna parts becomes large, isolation of the antenna parts may be improved. For example, in FIG. 4, the first antenna parts 211 and 212 are disposed at lower left corner and lower right corner of the substrate 260, respectively, and the second antenna part 220 is disposed in the center of an upper side.

The first isolators 231 and 232 and the second isolators 241 through 244 are disposed between the first antenna parts 211 and 212 and the second antenna part 220, respectively. Here, the isolators may improve isolation of the first antenna parts 211 and 212 and the second antenna part 220.

In a case in which signals are radiated from the first antenna parts 211 and 212, surface currents may flow from the first antenna parts 211 and 212 to the second antenna part 220. Here, the surface currents may have an influence on the second antenna part 220. Therefore, interference may likely be generated between the first antenna parts 211 and 212 and the second antenna part 220.

The first isolators 231 and 232 and the second isolator 241 through 244 electrically extend paths of the surface currents flowing between the antenna parts. Therefore, currents arriving at the respective antenna parts may be attenuated due to the surface currents generating interference between the two antenna parts, which may ultimately generate an effect that a spacing distance between the first antenna parts 211 and 212 and the second antenna part 220 is increased. Therefore, isolation of the antenna parts may be improved.

In addition, the first isolators 231 and 232 and the second isolator 241 to 244 may also reduce interference provided to another antenna part by radiation patterns of the respective antenna parts. The respective antenna parts may interfere with each other in the air, and the first isolators 231 and 232 and the second isolators 241 to 244 may be disposed on interference paths in the air, thereby improving the isolation of the antenna parts.

Here, the first isolators 231 and 232 are disposed adjacent to at least one antenna part so as to be coupled to the corresponding antenna part. In addition, the second isolators 241 to 244 may be disposed so as not to be adjacent to the antenna part.

The first isolators 231 and 232 are coupled to a specific antenna pattern to assist in radiation characteristics of the antenna part, and may be disposed between the first antenna parts 211 and 212 and the second antenna part 220 or be disposed between the first antenna parts 211 and 212 to improve the isolation of the antenna parts. Here, a coupling target antenna part of the first isolators 231 and 232 may be the first antenna parts 212 and 212 or the second antenna part 220.

Positions, sizes, and shapes, of the first isolators 231 and 232 and the second isolators 241 to 244 may be independently designed. Therefore, radiation characteristics of the antenna parts and isolation of the antenna parts may be efficiently designed. For example, in a case in which radiation characteristics of the first antenna parts 211 and 212 are desired to be adjusted and isolation of the first antenna parts 211 and 212 are desired to be improved, the isolation of the first antenna parts 211 and 212 may be improved through the second isolators 241 through 244 after the radiation characteristics of the first antenna parts 211 and 212 are improved through the first isolators 231 and 232.

The antenna apparatus 200 for multiple communications according to one or more embodiments does not necessarily include both of the first isolators 231 and 232 and the second isolators 241 to 244. For example, the antenna apparatus 200 may include only one of the first isolators 231 and 232 and the second isolators 241 through 244 or may not include the first isolators 231 and 232 and the second isolators 241 through 244, depending on a specification, a size, and a type of antenna, that are desired.

That is, the first isolators 231 and 232 and the second isolator 241 to 244 may serve to extend a distance traveled between the first antenna parts 211 and 212 and the second antenna part 220 by the surface current. Therefore, in a case in which the spacing distance satisfies desired isolation of the first antenna parts 211 and 212 and the second antenna part 220, the first isolators 231 and 232 and the second isolator 241 to 244 may not be included in the antenna apparatus 200.

For example, the first isolator 231 and the second isolator 241 may have an L-shape extending from the substrate 260 then perpendicularly toward one pattern 211 of the first antenna parts, and the first isolator 232 and the second isolator 242 may have an L-shape extending from the substrate 260 then perpendicularly toward the other pattern 212 of the first antenna parts. For example, the second isolator 243 may have a flag shape on one side of the second antenna part 220. For example, the second isolator 244 may have a flag shape on the other side of the second antenna part 220.

The feed parts 251 through 253 feed power to the first antenna parts 211 and 212 and/or the second antenna part 220. The surface currents flow in the first antenna parts 211 and 212 and/or the second antenna part 220 in relation to the feed parts 251 to 253, such that signals are radiated.

The substrate 260 provide spaces, which are electrical grounds, to the first antenna parts 211 and 212 and the second antenna part 220. For example, a communications module processing signals transmitted and received through the antenna part are mounted on the substrate 260.

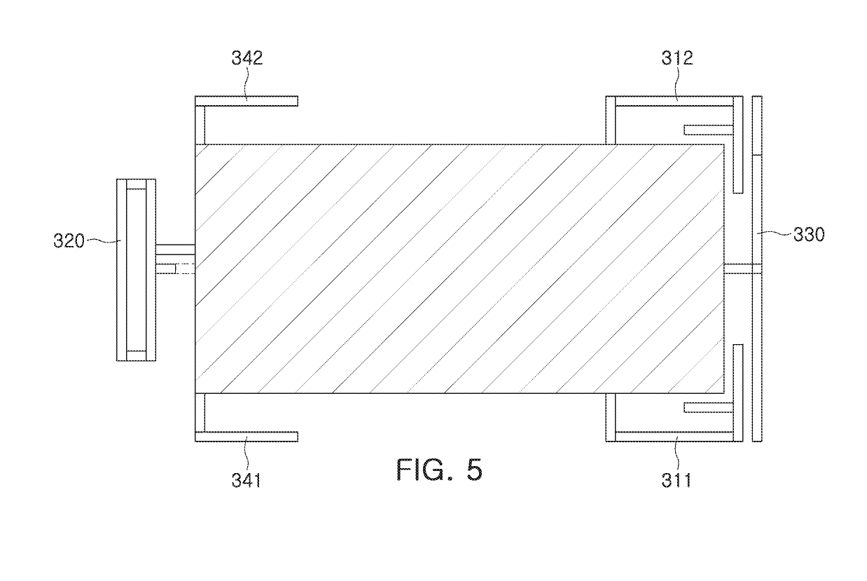

FIG. 5 is a view illustrating a layout of an antenna apparatus for multiple communications according to an embodiment. Referring to FIG. 5, first antenna parts 311 and 312 disposed at a lower right corner and a upper right corner of the substrate, respectively. A second antenna part 320 is disposed on a left edge of the substrate.

Isolation of the first antenna parts 311 and 312 may be deteriorated, and yet the isolation of the first antenna parts 311 and 312 and the second antenna part 320 may be improved, as compared to a layout of an antenna of FIG. 4. For example, a first isolator 330 is disposed between antenna patterns of the first antenna parts 311 and 312. In addition, second isolators 341 and 342 are disposed between the first antenna parts 311 and 312 and the second antenna part 320. That is, the first isolator 330 is also disposed between the first antenna parts 311 and 312 for the purpose of the isolation of the first antenna parts 311 and 312.

Referring to FIGS. 1 through 5, in the antenna apparatus according to one or more embodiments, even though a plurality of antennas are integrated in a small space in order to perform the multiple communications, isolation of the antennas may not be deteriorated. That is, in the antenna apparatus according to one or more embodiments, the plurality of antennas may be integrated in a small space in order to perform multiple communications, thereby securing price competitiveness and spatial flexibility, and an isolation problem that may occur as a result may be prevented.

In each embodiment, types or shapes of antenna patterns included in each of the first and second antenna parts are not particularly limited as long as the antenna patterns function as multi-antennas supporting multiple communications of which communications schemes are different from each other. The antenna pattern may be, for example, a planar inverted F antenna (PIFA), a dipole antenna, a monopole antenna, a loop antenna, or an inverted L-type antenna. Several antennas that may be used as the antenna pattern will be described with reference to FIGS. 6 through 11.

FIG. 6 is a view illustrating a dipole antenna as a type of antenna of the antenna apparatus according to one or more embodiments. Referring to FIG. 6, an antenna pattern 420 included in the first or second antenna part is a dipole antenna. Therefore, the antenna pattern 420 receives power fed through a central portion of a conducting wire to thereby be symmetrically operated in a vertical or horizontal direction in relation to the center of the antenna apparatus. Isolators 441, 442, and 443 are disposed adjacent to the antenna pattern 420.

FIG. 7 is a view illustrating an antenna apparatus having a monopole according to one or more embodiments. Referring to FIG. 7, an antenna pattern 520 included in the first or second antenna part is a monopole antenna. Therefore, the antenna pattern 520 may have a vertical linear or spiral conductor operated as a half of the monopole antenna. Isolators 541, 543, and 544 are disposed adjacent to the antenna pattern 520.

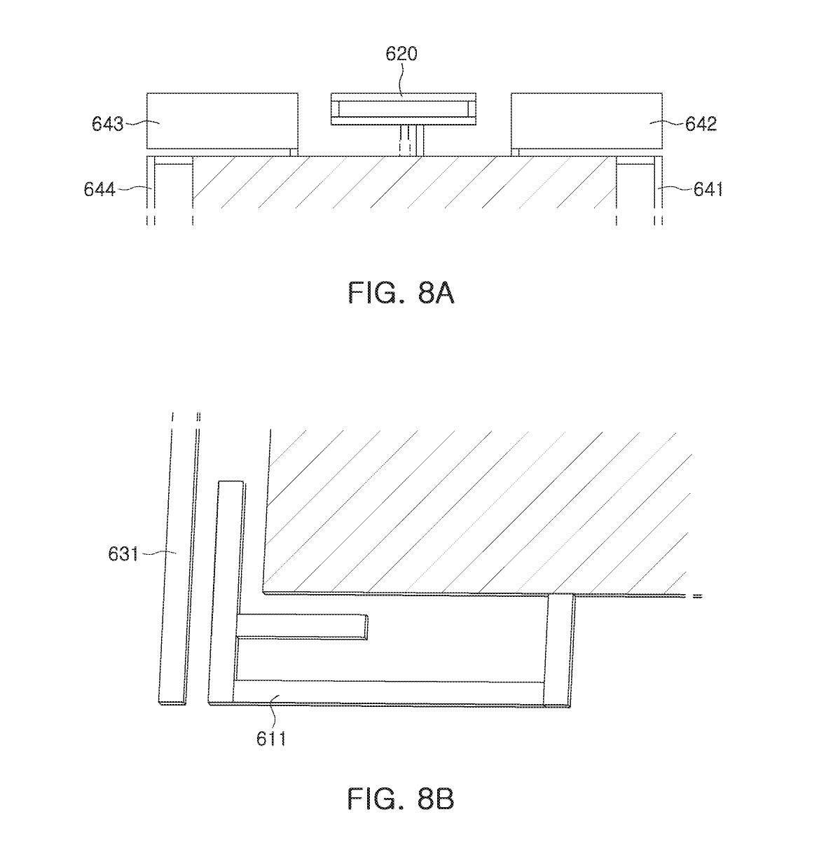

FIGS. 8A and 8B are views illustrating an antenna apparatus having a loop antenna according to one or more embodiments. Referring to FIGS. 8A and 8B, a first antenna pattern 611 and/or a second antenna pattern 620 are loop antennas. Therefore, the first antenna pattern 611 and/or the second antenna pattern 620 may have a vertical linear or spiral conductor operated as a half of a dipole antenna. A first isolator 631 and second isolators 641, 642, 643, and 644 are disposed between the first antenna pattern 611 and the second antenna pattern 620.

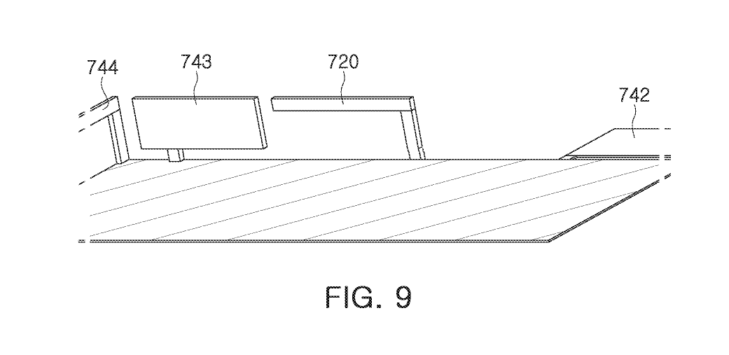

FIG. 9 is a view illustrating an antenna apparatus having an inverted L-type three-dimensional antenna according to one or more embodiments. Referring to FIG. 9, an antenna pattern 720 included in the first or second antenna part is an inverted L-type three-dimensional antenna similar to the PIFA. The inverted L-type three-dimensional antenna can be used as a long frequency and a middle frequency antenna, and has a shape an inverted letter ‘L’ by vertically bending one or several horizontally extending conductive wires downwardly from one end portion. For example, in a case in which an antenna length is ½ of a desired wavelength, such that the desired wavelength is long in resonating the antenna, the inverted L-type three-dimensional antenna is operated as a ground antenna having an antenna length of ¼ or less of the desired wavelength. Isolators 741 through 744 are disposed adjacent to the antenna pattern 720.

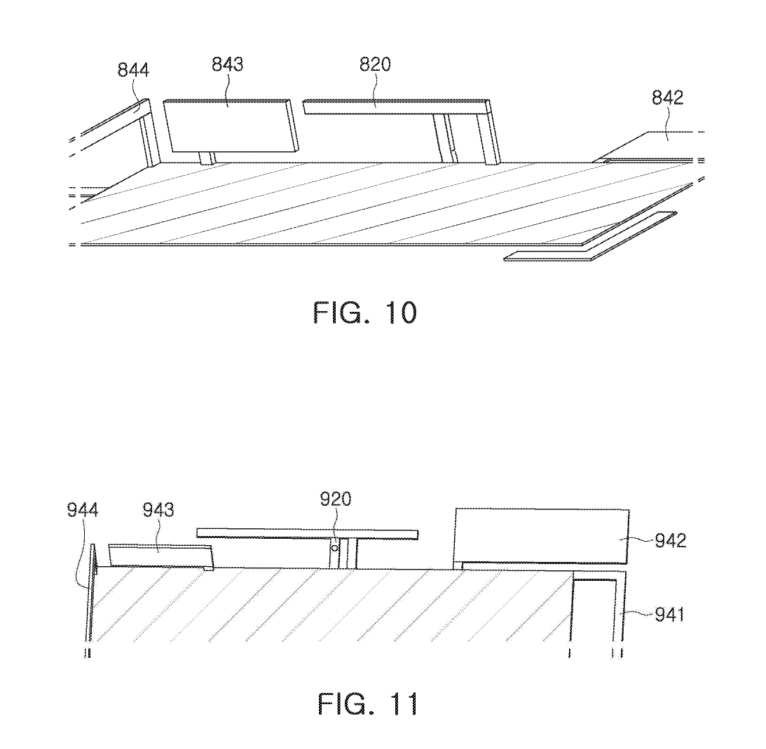

FIG. 10 is a view illustrating an antenna apparatus having an inverted F-type three-dimensional antenna according to one or more embodiments. Referring to FIG. 10, an antenna pattern 820 included in the first or second antenna part is an inverted F-type three-dimensional antenna similar to the PIFA. The inverted F-type three-dimensional antenna is a name given since an entire shape thereof is similar to an inverted shape of an alphabet F. The inverted F-type three-dimensional antenna can be relatively miniaturized as compared to another antenna that uses the same frequency band, has a radiation pattern similar to an omni-directional radiation pattern, has a relatively high gain and a relatively wide bandwidth, and has a low specific absorption rate (SAR). Isolators 842, 843, and 844 are disposed adjacent to the antenna pattern 820.

FIG. 11 is a view illustrating an antenna apparatus having an inverted F-type antenna according to one or more embodiments. Referring to FIG. 11, an antenna pattern 920 included in the first or second antenna part is an inverted F-type antenna similar to the PIFA. In addition, isolators 941 through 944 are disposed adjacent to the antenna pattern 920. Positions, shapes, and sizes, of the isolators are not limited as long as the isolators improve isolation of the first and second antenna parts. The isolators will be described with reference to FIGS. 12A through 15C, but are not limited thereto.

FIGS. 12A through 12C are views illustrating a three-dimensional shape of an isolator for the antenna apparatus according to one or more embodiments. Referring to FIGS. 12A through 12C, first isolators 1031 through 1033 and second isolators 1041 through 1043 are each disposed between first antenna parts 1011 through 1013 and second antenna parts 1021 through 1023, respectively, and have a three-dimensional shape. Third isolators 1044 through 1046 are each disposed between the second isolators 1041 through 1043 and the second antenna parts 1021 through 1023, respectively. The first isolators 1031 through 1033 and the second isolators 1041 through 1043 not only serve to attenuate surface currents flowing between the first antenna parts 1011 to 1013 and the second antenna parts 1021 to 1023, but also adjust interference from signals radiated through the first antenna parts 1011 to 1013 and the second antenna parts 1021 to 1023 in the air and radiation characteristics of the antenna parts. In a case in which the first isolators 1031 to 1033 and the second isolators 1041 to 1043 have a three-dimensional shape, the interference of the radiated signals in the air and the radiation characteristics of the antenna parts may be efficiently adjusted.

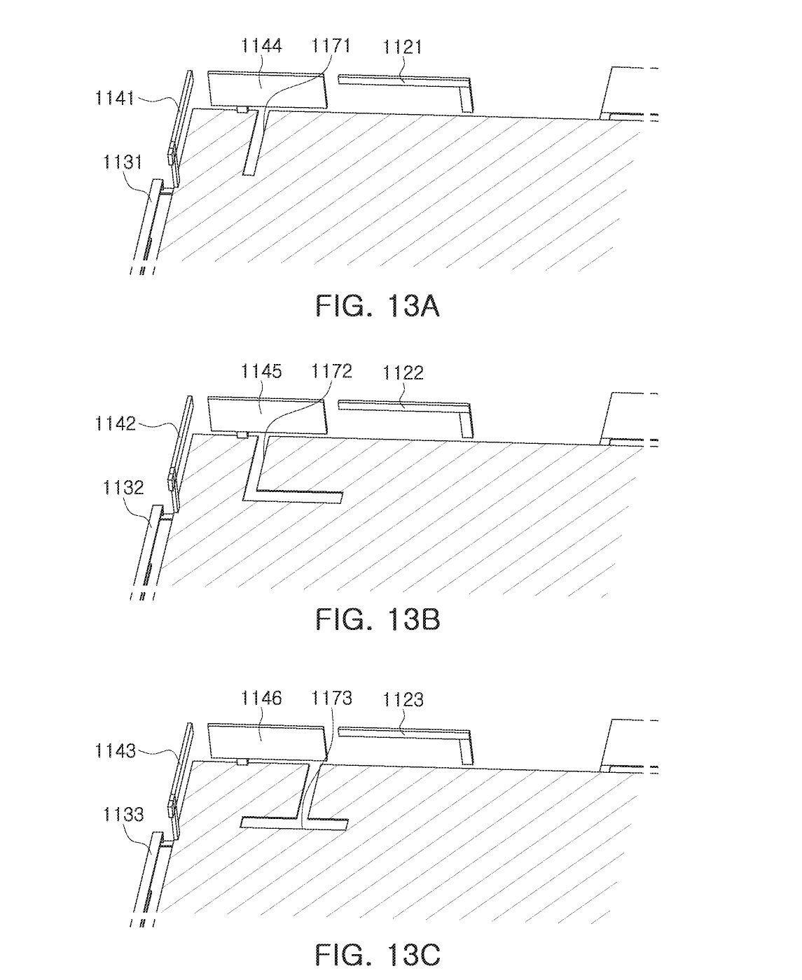

FIGS. 13A through 13C are views illustrating an antenna apparatus having a slit shaped isolator according to one or more embodiments. Referring to FIGS. 13A to 13C, first isolators 1131 through 1133 and second isolators 1141 through 1143 are respectively disposed between antenna patterns 1121 through 1123 included in a first or second antenna part, and slits 1171 through 1173 which extend through a portion of a substrate. Third isolators 1144 through 1146 are each disposed between the second isolators 1141 through 1143 and the antenna patterns 1121 through 1123, respectively.

The slits 1171 to 1173 are formed on virtual lines connecting the antenna patterns 1121 through 1123, and serve as barriers to the paths of surface currents. The slits 1171 through 1173, the first isolators 1131 to 1133, the second isolators 1141 to 1143, and the third isolators 1144 through 1146 combine with each other, such that a distance surface currents must travel between antennas is increased. Therefore, isolation of the antenna patterns 1121 to 1123 as compared to a structural spacing distance between the antenna patterns 1121 to 1123 may be further improved. The antenna apparatus according to one or more embodiments may substitute each of the first isolators 1131 through 1133 and the second isolators 1141 through 1144 with the slits 1171 to 1173.

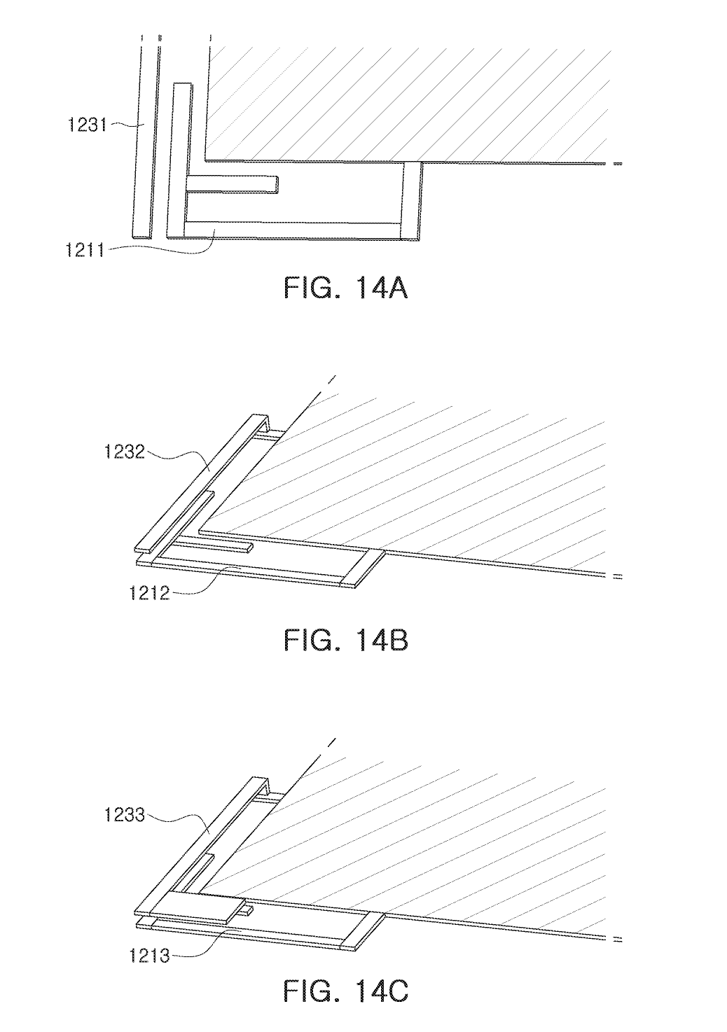

FIGS. 14A through 14C are views illustrating first isolators of the antenna apparatus according to one or more embodiments. Referring to FIG. 14A, a first isolator 1231 coupled to an antenna apparatus and coextends with about a half of the antenna pattern 1211. Referring to FIG. 14B, a first isolator 1232 coupled to an antenna apparatus and disposed overlap the antenna pattern 1212 when viewed from the top. A length of a first isolator 1233 coupled to an antenna apparatus in FIG. 14C is longer than, and overlaps more of the antenna pattern 1213 than that of the first isolator 1232 of FIG. 14B.

The coupling of the first isolators 1231 through 1233 may have the largest influence on connection points between the antenna patterns 1211 through 1213 and feed parts in the antenna patterns 1211 through 1213. Therefore, the isolators 1231 through 1233 have lengths at least long enough to be coupled to the connection points. In addition, the longer the lengths of the first isolators 1231 through 1233, the larger the influence of the coupling of the first isolators 1231 through 1233 on radiation characteristics of the antenna patterns 1211 through 1213. In addition, radiation directions of the antennas may be adjusted depending on positions at which the first isolators 1231 through 1233 cover, or overlap, the antenna patterns 1211 through 1213.

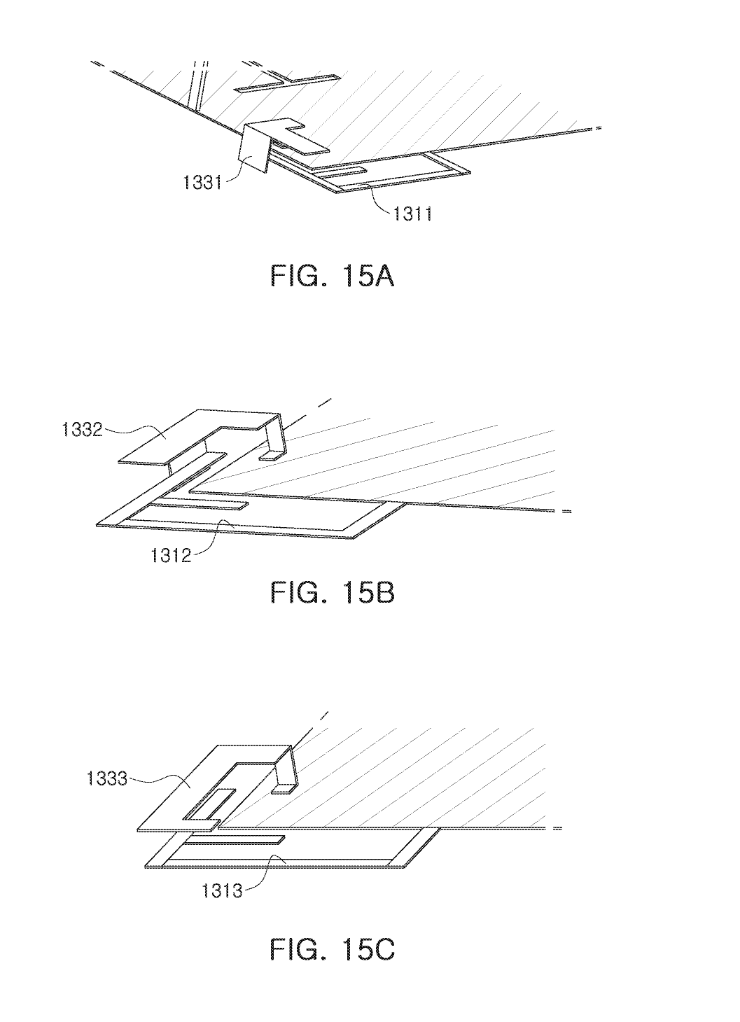

FIGS. 15A through 15C are views illustrating three-dimensional shape of the first isolators of the antenna apparatus for multiple communications according to one or more embodiments. Referring to FIG. 15A, a first isolator 1331 coupled to an antenna pattern 1311 is short enough to be coupled to a connection point of a feed part to the antenna pattern 1311. A length of a first isolator 1332 coupled to an antenna pattern 1312 in FIG. 15B is relatively longer than that of the first isolator 1331 of FIG. 15A. A length of a first isolator 1333 coupled to an antenna pattern 1313 in FIG. 15C is relatively longer than that of the first isolator 1332 of FIG. 15B.

As set forth above, in an antenna apparatus for multiple communications according to one or more embodiments, antennas supporting multiple communications of which communications schemes are different from each other are integrated in one module and isolation of the plurality of antennas may be maintained. Therefore, in the antenna apparatus for multiple communications according to one or more embodiments, price competitiveness and spatial flexibility may be achieved, and the isolation of the plurality of antennas and radiation characteristics of the antennas may be improved.

Therefore, the antenna apparatus for multiple communications according to one or more embodiments may be mounted in and an appearance of an apparatus desired to have transmission and reception of signals for multiple communications and a wireless local area network (WLAN) access environment such as a television (TV), a refrigerator, an air conditioner, or other device, and may be used in all desired apparatuses that may be embedded so as not to be viewed from the outside.

As a non-exhaustive example only, a device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

The apparatuses, units, modules, devices, and other components illustrated in FIGS. 1-15C that perform the operations described herein through the description are implemented by hardware components. Examples of hardware components include communicators, controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIG. 3. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna apparatus comprising:
a substrate;
a first antenna pattern extending from the substrate in a lateral direction and configured to transmit and receive first communications signals; and
a second antenna pattern spaced apart from the first antenna pattern, extending from the substrate in another lateral direction, and configured to transmit and receive second communications signals.

2. The antenna apparatus of claim 1, wherein the substrate has a hexahedral shape, and
the first and second antenna patterns are disposed adjacent to corners of the substrate.

3. The antenna apparatus of claim 1, further comprising:
a third antenna pattern spaced apart from the first and second antenna patterns, extending from the substrate in the lateral direction, and configured to transmit and receive the first communications signals.

4. The antenna apparatus of claim 3, wherein the substrate has a hexahedral shape,
the first and third antenna patterns are disposed adjacent to opposite corners of a side of the substrate, respectively, and
the second antenna pattern is disposed in a center of a side opposite to the side of the substrate.

5. The antenna apparatus of claim 3, further comprising:
a fourth antenna pattern spaced apart from the first to third antenna patterns, extending from the substrate in the other lateral direction, and configured to transmit and receive the second communications signal.

6. The antenna apparatus of claim 5, wherein the substrate has a hexahedral shape, and
the first, second, third, and fourth antenna patterns are disposed adjacent to each corner of the substrate, respectively.

7. The antenna apparatus of claim 1, further comprising:
a communications module mounted on the substrate in a vertical direction and configured to process the first and second communications signals,
wherein the substrate has a first surface configured to receive the communications module and provide electrical ground regions for the first and second antenna patterns.

8. The antenna apparatus of claim 1, further comprising:
a first isolator extending from the substrate in the lateral direction and adjacent to the first antenna pattern or the second antenna pattern.

9. The antenna apparatus of claim 1, further comprising:
a second isolator extending from the substrate in the lateral direction and disposed between the first and second antenna patterns configured to electrically isolate the first and second antenna patterns from each other.

10. The antenna apparatus of claim 9, wherein the second isolator further extends from the substrate in a vertical direction.

11. An antenna apparatus comprising:
a substrate;
a first antenna part comprising at least one antenna pattern disposed on an edge of the substrate and configured to transmit and receive first communications signals;
a second antenna part comprising at least one antenna pattern disposed on the edge of the substrate and configured to transmit and receive second communications signals; and
an isolator disposed between the first and second antenna parts and configured to lengthen a surface current path between the first and second antenna parts.

12. The antenna apparatus of claim 11, wherein the substrate has a hexahedral shape,
the first antenna part includes first and third antenna patterns disposed adjacent to opposite corners on one side of the substrate, respectively,
the second antenna part includes a second antenna pattern disposed in a center of the other side of the substrate, and
the isolator is disposed adjacent to a corner of the other side of the substrate.

13. The antenna apparatus of claim 11, further comprising:
a communications module mounted on the substrate and configured to process the first and second communications signals,
wherein the substrate is configured to provide ground regions for the first and second antenna parts.

14. The antenna apparatus of claim 11, further comprising:
a second isolator extending from the substrate in another lateral direction and disposed between the first and second antenna parts and configured to lengthen a distance of the surface current path between the first and second antenna parts.

15. The antenna apparatus of claim 14, further comprising:
a slit disposed between the first and second antenna parts and extending through a portion of the substrate.

16. The antenna apparatus of claim 15, wherein the slit is straight, has an L shape or a T shape.

17. The antenna apparatus of claim 12, wherein the isolator overlaps a portion of the antenna pattern.

18. The antenna apparatus of claim 8, wherein the isolator overlaps a portion of the antenna pattern.
